(19) United States
(12) Patent Application Publication
(10) Pub. No.: US 2009/0296163 A1
(43) Pub. Date: Dec. 3, 2009

(54) Image Processing Apparatus and Energy-Saving Control Method Thereof

(75) Inventor: Toshitsugu Koura, Kyoto-shi (JP)

Correspondence Address: HOGAN & HARTSON L.L.P., 1999 AVENUE OF THE STARS, SUITE 1400, LOS ANGELES, CA, 90067, US

(73) Assignee: Murata Machinery, Ltd., Kyoto (JP)

(21) Appl. No.: 12/434,516

(22) Filed: May 1, 2009

(30) Foreign Application Priority Data
Jun. 2, 2008 (JP) 2008-144613

(51) Int. Cl. H04N 1/00

(52) U.S. Cl. 358/403

(57) ABSTRACT

An image processing apparatus includes a facsimile communication unit that transmits/receives data by being connected with a PSTN, a network communication unit that transmits/receives data by being connected with an area network, a memory that stores the data, a power supply that supplies power to components, and a determination unit that determines whether or not to release an energy-saving mode in which the power is supplied only to a portion of the components. When operating in the energy-saving mode, at least the facsimile communication unit, the network communication unit, the memory, and the determination unit are supplied with power. When the facsimile communication unit receives data when operating in the energy-saving mode, the received data is stored in the memory. When the network communication unit receives a request from a terminal device provided on the area network when operating in the energy-saving mode, the determination unit determines whether or not to release the energy-saving mode in accordance with a content of the received request.

### CROSS-REFERENCE TO RELATED APPLICATIONS

This application claims priority under 35 U.S.C. 119 to Japanese Patent Application No. 2008-144613, filed on Jun. 2, 2008, which application is hereby incorporated by reference in its entirety.

### BACKGROUND OF THE INVENTION

1. Field of the Invention

The present invention relates to an image processing apparatus that operates in an energy-saving mode and, in particular, to an image processing apparatus and an energy-saving control method thereof in which image data can be received and stored at the time of operating in an energy-saving mode.

2. Description of the Related Art

In a Multi Functional Peripheral (MFP) including a plurality of functions, such as a facsimile function, a scanner function, a printer function, and a copying function, or the like, an energy-saving mode is required to achieve power saving. In order to receive a facsimile at any time, it is common in an MFP including a facsimile function to supply power in an energy-saving mode to portions that are necessary for facsimile reception.

An MFP has been proposed that aims at power saving by releasing the energy-saving mode in stages and reducing the number of printings performed on paper. When this MFP receives a facsimile at the time of operating in the energy-saving mode, power supply is restored only for components that are used to receive data via facsimile, and the received data is stored in a memory. When the energy-saving mode is completely released, an image based on the received data stored in the memory is printed on paper.

In another conventional MFP, an energy-saving mode is completely released when a release of the energy-saving mode is triggered by causes other than a detection of facsimile reception or when an amount of data stored in a memory exceeds a set value at the time of a release of the energy-saving mode. When releasing the energy-saving mode in response to the detection of facsimile reception, the MFP resumes power supply to a main Central Processing Unit (CPU) and, similarly to the above MFP, stores received data in the memory. Thus, after shifting to the energy-saving mode, the conventional MFP releases the energy-saving mode in stages, and uses the energy-saving mode more effectively.

Recently, accompanying the increase of speed of a Local Area Network (LAN) including a wireless LAN and facilitation of buildup of the LAN, an MFP that includes a network printer function and a network facsimile function in addition to the above facsimile function has been widely used. For such an MFP that can be connected with the LAN, operations of the conventional MFP for releasing the energy-saving mode are insufficient.

An MFP that can be connected with the LAN is required to recognize a request from a terminal device connected with the same LAN even when the MFP operates in the energy-saving mode. Further, depending on the content of the request from the terminal device, the MFP that can be connected with the LAN may require only a portion of components to be operated. Therefore, it is necessary to release the energy-saving mode in stages in accordance with the content of the request from the terminal device.

### SUMMARY OF THE INVENTION

In order to overcome the problems described above, the present invention provides an image processing apparatus and an energy-saving control method thereof in which a signal reception in a network communication or in a facsimile communication can be recognized at the time of operating in an energy-saving mode, and the energy-saving mode can be released in accordance with a content received in the network communication.

One embodiment of the invention provides a facsimile communication unit that transmits/receives data by being connected with a Public Switched Telephone Network (PSTN), a network communication unit that transmits/receives data by being connected with an area network, a memory that stores the data, and a determination unit that determines whether or not to release an energy-saving mode in which power is supplied only to a portion of components. At least the facsimile communication unit, the network communication unit, the memory, and the determination unit are supplied with power at a time of operating in the energy-saving mode. When the facsimile communication unit receives data at the time of operating in the energy-saving mode, the received data is stored in the memory, and when the network communication unit receives a request from a terminal device provided on the area network at the time of operating in the energy-saving mode, the determination unit determines whether or not to release the energy-saving mode in accordance with a content of the received request.

According to this embodiment of the invention, the image processing apparatus stores data received by the facsimile communication unit in the memory at the time of energy-saving mode, and thus does not need to release the energy-saving mode each time a facsimile is received. When a request is received from the terminal device via the area network while the image processing apparatus operates in the energy-saving mode, components to which power is supplied can be determined in accordance with the request.

According to another embodiment of the invention, when the facsimile communication unit receives data at the time of operating in the energy-saving mode, the determination unit determines whether or not to release the energy-saving mode in accordance with an amount of data stored in the memory.

Another embodiment of the invention provides a printer unit that stores images based on data stored in the memory. Power supply to the printer unit is cut at the time of operating in the energy-saving mode, and when the network communication unit receives the request from the terminal device provided on the area network at the time of operating in the energy-saving mode, and when the received request requires a printing operation performed by the printer unit, the determination unit gives an energy-saving-mode release instruction.

Another embodiment of the invention provides a scanner unit that scans an image of an original document. According to this embodiment, power supply to the scanner unit is cut at the time of operating in the energy-saving mode, and when the network communication unit receives a request from the terminal device provided on the area network at the time of operating in the energy-saving mode, and when the received request requires a scanning operation performed by the scanner unit, the determination unit gives an energy-saving-mode release instruction.

Another embodiment of the invention provides a first power supply circuit that always supplies power to a first section that operates even in the energy-saving mode and a second power supply circuit that supplies power to a second section, excluding the first section, when the energy-saving mode is released. The first section includes at least the facsimile communication unit, the network communication unit, the memory, and the determination unit. That is, when the image processing apparatus operates in the energy-saving mode, only the first power supply circuit operates, and when the energy-saving mode is released, each of the first power supply circuit and the second power supply circuit operates.

Another embodiment of the invention provides a temperature detecting unit that detects a temperature of an inside of the image processing apparatus. At the time of shifting from a normal mode in which power is also supplied to a printer unit to the energy-saving mode, after the power supply is cut with respect to at least the printer unit, when the determination unit confirms that the temperature detected by the temperature detecting unit falls below a predetermined value, the power supply is cut with respect to at least the temperature detecting unit, and thus the normal mode may completely shift to the energy-saving mode. That is, when shifting to the energy-saving mode, until the temperature detected by the temperature detecting unit falls below the predetermined value, the normal mode does not completely shift to the energy-saving mode in which the power is supplied only to electric components that always need the power supplied.

Another embodiment of the invention provides a first power supply circuit that always supplies power to a first section that operates even in an energy-saving mode, a second power supply circuit that supplies power to a second section that operates only in a normal mode, and a third power supply circuit that supplies power to a third section, excluding the first section and the second section, which third section does not operate when the normal mode has completed shifted to the energy-saving mode. The first section includes at least the facsimile communication unit, the network communication unit, the memory, and the determination unit, and the third section includes at least a temperature detecting unit.

According to the above embodiment, when the image processing apparatus has completely shifted from the normal mode to the energy-saving mode, only the first power supply circuit operates, and when the energy-saving mode is released, each of the first through third power supply circuits operates.

According to the present invention, when a facsimile communication unit receives data at the time of operating in an energy-saving mode, the received data can be stored in a memory, and thus it is not necessary to release the energy-saving mode each time a facsimile is received. When a network communication unit receives data at the time of operating in the energy-saving mode, it can be determined whether or not to release the energy-saving mode in accordance with a content of a request of a terminal device, and thus it is not necessary to release the energy-saving mode each time the network communication unit receives data. Accordingly, compared with a conventional configuration that releases the energy-saving mode each time a communication with an outside is confirmed, the present invention performs necessary operations with minimum components, thereby further reducing power consumption.

Other features, elements, processes, steps, characteristics and advantages of the present invention will become more apparent from the following detailed description of embodiments of the present invention with reference to the attached drawings.

### BRIEF DESCRIPTION OF THE DRAWINGS

FIG. 1 is a block diagram illustrating a configuration of an MFP according to an embodiment of the present invention.

FIG. 2 is a flowchart illustrating operations performed in a normal mode of the MFP according to an embodiment of the present invention.

FIG. 3 is a flowchart illustrating operations performed in an energy-saving mode of the MFP according to an embodiment of the present invention.

### DETAILED DESCRIPTION OF EMBODIMENTS OF THE INVENTION

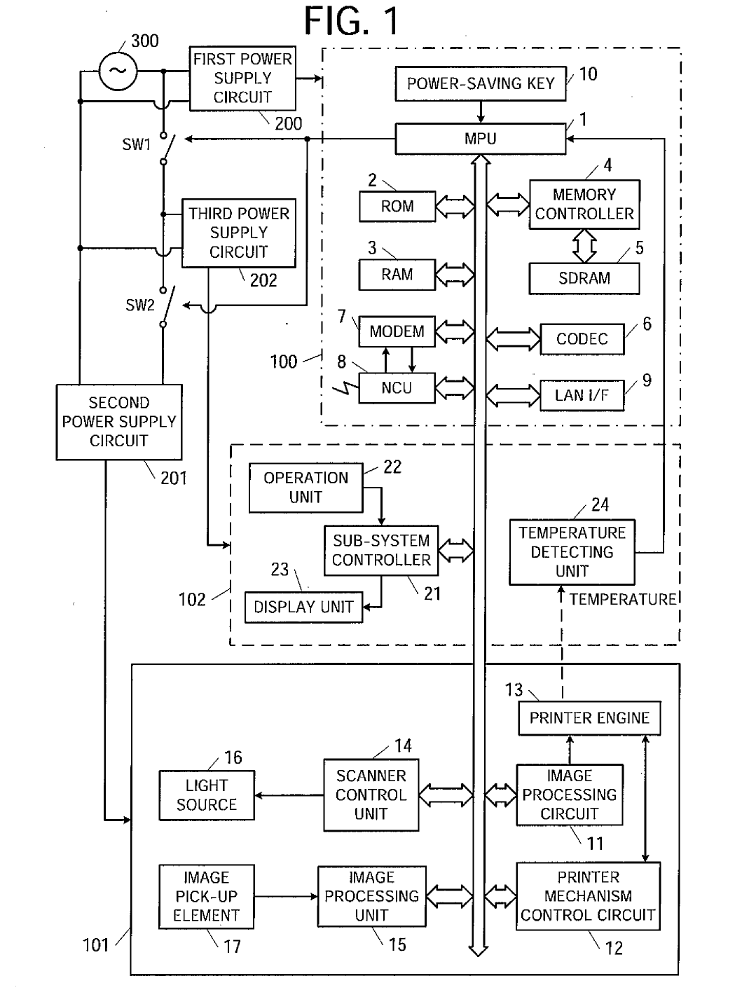

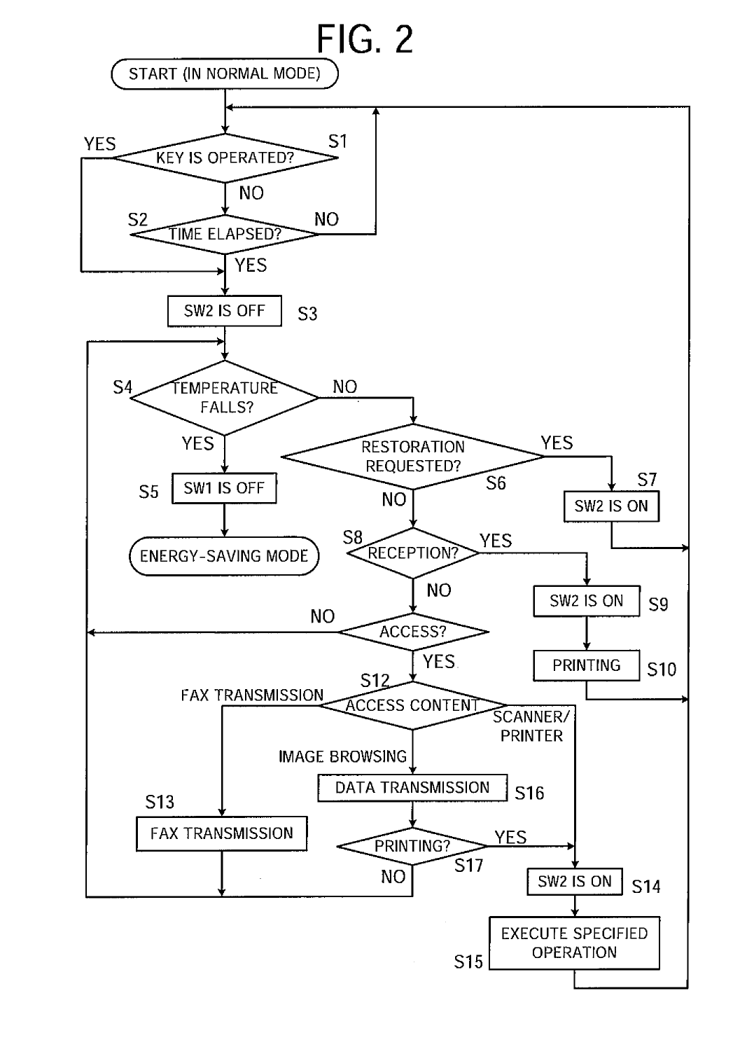

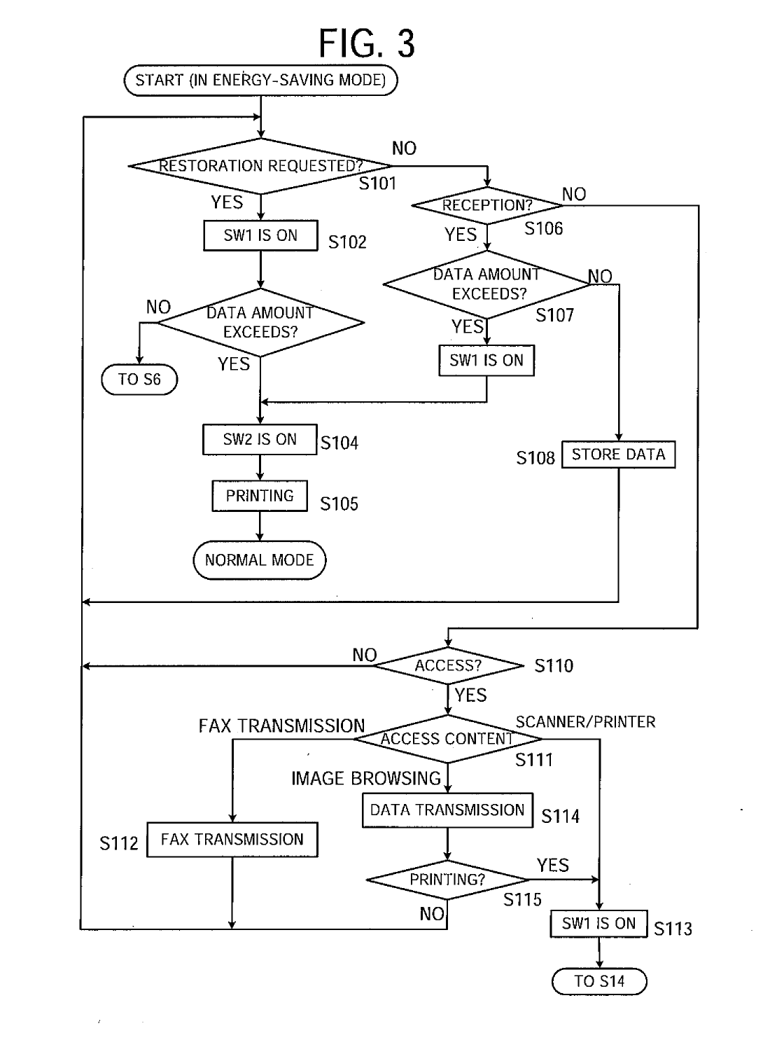

With reference to the drawings, an image processing apparatus and an energy-saving control method thereof of the present invention will be described in an example of an MFP including a facsimile function. FIG. 1 is a block diagram illustrating a configuration of the MFP that defines the image processing apparatus of the present invention. FIG. 2 is a flowchart illustrating operations performed when a normal mode shifts to an energy-saving mode in the MFP. FIG. 3 is a flowchart illustrating operations performed when the energy-saving mode shifts to the normal mode in the MFP.

The MFP of FIG. 1 includes a Micro Processing Unit (MPU) 1 as a main control unit that controls the entire apparatus, a Read Only Memory (ROM) 2, and a Random Access memory (RAM) 3. The MPU 1 reads out various programs stored in the ROM 2, and uses the RAM 3 as a work area for the read-out program to execute the program. The MPU 1 transmits/receives data to/from each block, which will be described later, via a bus to achieve various functions of the MFP.

As components used to achieve the facsimile function, the MFP of FIG. 1 includes a Synchronous Dynamic Random Access memory (SDRAM) 5 that stores image data to be transmitted/received and a memory controller 4 that controls the reading of the SDRAM 5 and the writing on the SDRAM 5.

The MFP of FIG. 1 further includes a Coder and Decoder (CODEC) 6 that compresses and expands image data, a Modulator and Demodulator (MODEM) 7 that mutually converts an audio signal that is transmitted/received via a PSTN and a data string that is based on the image data, and a Network Control Unit (NCU) 8 that connects the MFP with the PSTN.

The MFP of FIG. 1 also includes a LAN interface 9 that is connected to the LAN provided as a network. Through the LAN interface 9, the MFP communicates with a terminal device such as a Personal Computer (PC) connected with the LAN. Accordingly, based on an access from the terminal device provided on the LAN connected through the LAN interface 9, a network printer function, a network scanning function, or a network facsimile function can be achieved. A Wide Area Network (WAN) may be used in place of the LAN.

In order to implement a scanner function that is used to scan an image of an original document, the MFP of FIG. 1 includes a scanner control unit 14 and an image processing unit 15 that are controlled by the MPU 1, a light source 16 that is driven by the scanner control unit 14, and an image pick-up element 17 that converts light reflected from an original document into an electric signal. That is, the light source 16 composed of a white fluorescent lamp, a cold-cathode tube, or a white Light Emitting Diode (LED) irradiates the original document with light. Then, a Charge Coupled Device (CCD) line sensor, which constitutes the image pick-up element 17, receives the reflected light, which represents the contrasting density of the original document, and thus an image of the original document is scanned.

In order to implement a printer function that is used to print the image on a paper, the MFP of FIG. 1 includes an image processing circuit 11 and a printer mechanism control circuit 12 that are controlled by the MPU 1, and a printer engine 13 which is used to print the image based on image data sent from the image processing circuit 11. The printer mechanism control circuit 12 drives each mechanism, such as a paper supply unit, a transfer unit, or a fuser, which together constitute the printer engine 13. The printer engine 13 is used to print the image on the paper based on the image data sent from the image processing circuit 11.

The MFP of FIG. 1 further includes a sub-system controller 21 that communicates with a main system operated by the MPU 1, an operation unit 22 that receives instructions from a user, and a display unit 23 that displays images. The sub-system controller 21, the operation unit 22, and the display unit 23 together constitute a sub system. Through this sub system, the instruction from the user received by the operation unit 22 is sent to the MPU 1 via the sub-system controller 21. The display unit 23, which is controlled by the sub-system controller 21, displays the images scanned by the scanner function, images received via facsimile, or images received through the LAN, for example. Further, a touch screen may be provided by displaying operation displays by the display unit 23 and by integrating the operation unit 22 and the display unit 23.

In the MFP of FIG. 1, a normal mode shifts to an energy-saving mode under certain conditions, such as when any instruction is not given by the user during a specific period of time. In the normal mode, power is supplied to every electronic component of the MFP. In the energy-saving mode, the power supply is limited only to the minimum necessary electronic components. The MFP of FIG. 1 includes a power-saving key 10 that is operated by the user. By operating the power-saving key 10, the user can instruct the MFP of FIG. 1 to shift the mode to the energy-saving mode and to restore the normal mode. Further, the MFP of FIG. 1 includes a temperature detecting unit 24 that detects the temperature of the printer engine 13. Thus, at the time of shifting to the energy-saving mode, the MFP can limit the power-supplied electronic components in stages in accordance with the temperature of the fuser of the printer engine 13, which temperature is detected by the temperature detecting unit 24.

The electronic components of the MFP are divided into a first section 100, a second section 101, and a third section 102. The first section 100 includes the MPU 1, the ROM 2, the RAM 3, the memory controller 4, the SDRAM 5, the CODEC 6, the MODEM 7, the NCU 8, the LAN interface 9, and the power-saving key 10. The second section 101 includes the image processing circuit 11, the printer mechanism control circuit 12, the printer engine 13, the scanner control unit 14, the image processing unit 15, the light source 16, and the image pick-up element 17. The third section 102 includes the sub-system controller 21, the operation unit 22, the display unit 23, and the temperature detecting unit 24.

The MFP of FIG. 1 further includes a first power supply circuit 200, a second power supply circuit 201, and a third power supply circuit 202 that respectively supply the first through third sections 100, 101, 102 with power. Each of the first through third power supply circuits 200, 201, 202 converts an Alternating-Current (AC) power, which is supplied by a commercial power 300, into a Direct-Current (DC) power, and supplies the respective first through third sections 100, 101, 102 with the DC power. The third power supply circuit 202 is connected with the commercial power 300 via a switch SW1, the second power supply circuit 201 is connected with the commercial power 300 via the switch SW1 and a switch SW2, and thus the first through third power supply circuits 200, 201, 202 are connected with the commercial power 300 in parallel.

In other words, terminals of the commercial power 300 are connected to terminals arranged on an input side of the first power supply circuit 200, and thus the DC power from the first power supply circuit 200 is continuously output to the first section 100. One terminal of the switch SW1 is connected to the commercial power 300, and another terminal of the switch SW1 is connected to a terminal arranged on an input side of the third power supply circuit 202. Thus, when the switch SW1 is turned on, the DC power from the third power supply circuit 202 is output to the third section 102. Similarly, the switch SW2, which is connected to the switch SW1 in series, is connected to one terminal arranged on an input side of the second power supply circuit 201. Thus, when the switches SW1, SW2 are turned on, the DC power from the second power supply circuit 201 is output to the second section 101.

Although the switches SW1, SW2 are connected in series between the commercial power 300 and the second power supply circuit 201 in FIG. 1, the switches SW1, SW2 may be connected in parallel. In other words, only the switch SW2 may be provided between the commercial power 300 and the second power supply circuit 201, and only the switch SW1 may be provided between the commercial power 300 and the third power supply circuit 202.

1. Operations in the Normal Mode in the Standby State

Operations performed when the MFP of FIG. 1 configured as described above is in the normal mode in a standby state are now described with reference to the flowchart of FIG. 2. When the MFP operates in the normal mode, the MPU 1 turns on the switches SW1, SW2, and the first through third power supply circuits 200, 201, 202 are connected with the commercial power 300 in parallel. Thus, the first through third power supply circuits 200, 201, 202 supply power to operate the first through third sections 100, 101, 102, respectively.

When the MFP ends an instructed operation and enters into the standby state in the normal mode, the MPU 1 determines whether or not the power-saving key 10 has been operated (S1). When the power-saving key 10 has not been operated (“NO” in S1), the MPU 1 confirms whether or not a prescribed period of time has elapsed after the MFP entered into the standby state (S2). When it is not confirmed that the prescribed period of time has elapsed (“NO” in S2), the process returns to S1, where the MPU 1 determines whether or not the power-saving key 10 has been operated.

When the MPU 1 determines that the power-saving key 10 has been operated (“YES in S1), or when the MPU 1 confirms that the prescribed period of time has elapsed after the MFP entered into the standby state (“YES” in S2), MPU 1 turns off the switch SW2 (S3). Thus, the second power supply circuit 201 and the commercial power 300 are electrically disconnected, and the power supply from the second power supply circuit 201 to the second section 101 is cut. In other words, the power supply is cut with respect to the image processing circuit 11, the printer mechanism control circuit 12, the printer engine 13, which are related to the printer function, and to the scanner control unit 14, the image processing unit 15, the light source 16, and the image pick-up element 17, which are related to the scanner function.

After the power supply from the second power supply circuit 201 is cut, the MPU 1 determines whether or not the temperature of the printer engine 13 detected by the temperature detecting unit 24 falls below a predetermined value (S4). When the temperature detecting unit 24, which is composed of a thermistor or other similar devices, detects the temperature of a fusing heater, which constitutes a portion of the printer engine 13, the MPU 1 determines based on the temperature of the fusing heater whether or not a printing operation can be performed immediately after the normal mode is restored.

When the temperature detected by the temperature detecting unit 24 falls below the predetermined value (“YES” in S4), the MPU 1 determines that the restoration of the printer engine 13 needs a certain period of time, and turns off the switch SW1 (S5). Accordingly, the third power supply circuit 202 and the commercial power 300 are electrically disconnected, and the power supply by the third power supply circuit 202 is cut with respect to the sub-system controller 21, the operation unit 22, the display unit 23, and the temperature detecting unit 24, which together constitute the third section 102. Thus, since the power supply by the second and third power supply circuits 201, 202 is cut, the state of the MFP completely shifts to the energy-saving mode in which only the first power supply circuit 200 always supplies power.

On the other hand, when the temperature detected by the temperature detecting unit 24 exceeds the predetermined value (“NO” in S4), the MPU 1 determines whether or not the power-saving key 10 or the operation unit 22 has been operated (S6). At this time, when the power-saving key 10 or the operation unit 22 has been operated by the user, and when the MPU 1 confirms a request for restoring the normal mode (“YES” in S6), the MPU 1 turns on the switch SW2 (S7). Thus, the second power supply circuit 201 and the commercial power 300 are connected, and the power supply from the second power supply circuit 201 to the second section 101 is resumed. In other words, in order to perform the operations through the scanner function or the printer function, the MFP restores the normal mode when an instruction is received through the operation unit 22, or the like. Then, the process returns to S1, where the MPU 1 determines whether or not the power-saving key 10 has been operated.

When the operation unit is operated while the MFP is in the standby state in the normal mode, based on the instruction given through the operation unit 22, each of the facsimile function, the printer function, or the scanner function is executed. When accessed by a terminal device through the LAN interface 9, based on the access content, an image browsing function, the facsimile function, the printer function, or the scanner function is executed. When a facsimile is received by the MODEM 7 and the NCU 8, an image of the received image data is printed on a paper.

When the operation of the power-saving key 10 or of the operation unit 22 by the user is not confirmed (“NO” in S6), the MPU 1 confirms whether or not a facsimile has been received by the MODEM 7 and the NCU 8 (S8). When the MPU 1 confirms the facsimile reception performed by the MODEM 7 and the NCU 8 (“YES” in S8), similarly to the operation of S7, the MPU 1 turns on the switch SW2 (S9). Thus, the power supply from the second power supply circuit 201 is resumed, and the MFP restores the normal mode. Accordingly, the power is supplied to the image processing circuit 11, the printer mechanism control circuit 12, and the printer engine 13.

In S8, when the NCU 8 confirms a calling from a destination facsimile machine and establishes a connection with the destination facsimile machine via the PSTN, the MPU 1 confirms the facsimile reception. Thus, the switch SW2 is turned on in S9, and the MFP restores the normal mode to print the image of the received image data on a paper (S10). The facsimile reception of the MFP is described below.

As described above, when the MFP restores the normal mode, a signal received through the NCU 8 is demodulated by the MODEM 7, and compressed image data is acquired and then temporarily stored in the SDRAM 5 by the memory controller 4. The image data stored in the SDRAM 5 is expanded by the CODEC 6, and thus image data of an original document transmitted from the destination facsimile machine is reproduced.

When the reproduced image data is sent to the image processing circuit 11, a format of the data is converted into a data format used for printing, and the data is further sent to a laser scanner unit, which constitutes the printer engine 13. Alternatively, the data may be sent to a print head such as an ink jet head. At the same time, a paper feed roller, the laser scanner unit, the print head, and the fusing heater, which together constitute the printer engine 13, are driven by the printer mechanism control circuit 12, and the image of the received original document is printed on a paper supplied in the printer engine 13.

When the facsimile reception is not confirmed (“NO” in S8), the MPU 1 confirms whether or not the terminal device has accessed the MFP via the LAN interface 9 (S11). At this time, when a signal reception via the LAN interface 9 is not confirmed (“NO” in S11), the process returns to S4, where the MPU 1 confirms the temperature detected by the temperature detecting unit 24. A signal transmitted from the terminal device provided on the LAN is received by the LAN interface 9, and the MPU 1 confirms the access from the terminal device (“YES” in S11). Based on the signal received by the LAN interface 9, the MPU 1 confirms a content requested by the terminal device through the access (S12).

When the content requested by the accessing terminal device indicates a facsimile transmission that uses the network facsimile function (“FAX transmission” of S12), the MPU 1 returns to the determining process of S4 after transmitting via facsimile the image data received by the LAN interface 9 (S13). When performing the facsimile transmission using the network facsimile function, such a transmission can be performed even when the power is not supplied to the scanner control unit 14, the image processing unit 15, the light source 16, and the image pick-up element 17.

When the image data transmitted from the accessing terminal device is received by the LAN interface 9 in S13, the memory controller 4 temporarily stores the image data in the SDRAM 5. Then, the image data stored in the SDRAM 5 is compressed by the CODEC 6, modulated by the MODEM 7, and transmitted to another facsimile machine with which the connection is established by the NCU 8.

When the request made by the terminal device accessing the MFP indicates a printing operation using the network printer function or an operation of scanning an image using the network scanner function (“scanner, printer” in S12), similarly to the operations in S7 and S9, the MPU 1 turns on the switch SW2 (S14). Thus, the power supply from the second power supply circuit 201 is resumed, and the MFP restores the normal mode.

The MFP can use the network printer function through the image processing circuit 11, the printer mechanism control circuit 12, and the printer engine 13, and the network scanner function through the scanner control unit 14, the image processing unit 15, the light source 16, and the image pick-up element 17. In accordance with the request from the terminal device accessing the MFP, the printing operation on the paper or the image scanning operation may be executed through the network printer function or the network scanner function, respectively (S15).

At the time of executing the printing operation through the network printer function, when the LAN interface 9 receives the data for the printing operation from the terminal device, the memory controller 4 temporarily stores the received data in the SDRAM 5. The data temporarily stored in the SDRAM 5 is then sent to the image processing circuit 11, converted into image data that is acceptable to the printer engine 13, and sent to the printer engine 13. Each function of the printer engine 13 is driven by the printer mechanism control circuit 12, and an image having the content requested by the terminal device is printed on the paper.

At the time of executing the image scanning operation through the network scanner function, in the case of using a Flat Bed Scanner (FBS) as the scanner unit, the scanner control unit 14 turns on the light source 16, and a carriage is moved at a constant speed in a sub-scanning direction. In the case of using an Auto Document Feeder (ADF) as the scanner unit, the scanner control unit 14 feeds an original document and controls the lighting of the light source 16 in accordance with the paper feeding timing.

When the image pick-up element 17 receives the reflected light from the original document arising from the lighting of the light source 16, the received light is converted into an electric signal with respect to each prescribed timing to take a sample therefrom, and image data is acquired by scanning the image of the original document line by line. The image data acquired based on the original document image is temporarily stored in the SDRAM 5 by the memory controller 4, and then compressed by the CODEC 6. The compressed image data is transmitted via the LAN interface 9 to the terminal device whose access is confirmed by the MPU 1 in S11.

When the content requested by the accessing terminal device indicates a browsing of the image of the image data stored in the SDRAM 5 (“image browsing” of S12), the MFP transmits the image data stored in the SDRAM 5 to the terminal device (S16). When the image data stored in the SDRAM 5 is read out by the memory controller 4, after being expanded by the CODEC 6, the image data is transmitted through the LAN interface 9 to the terminal device whose access is confirmed by the MPU 1 in S11. The image data stored in the SDRAM 5 may be transmitted to the terminal device without being expanded by the CODEC 6.

The terminal device, which has received the image data from the LAN interface 9, displays the image of the received image data on a display. Thus, the user can confirm the image data stored in the SDRAM 5 by browsing the image displayed by the terminal device after the facsimile reception. The user of the terminal device can instruct the MFP to print desired image data by selecting the image data desired to be printed on the paper and by operating the terminal device.

While the terminal device browses the image data via the LAN interface 9, the MPU 1 confirms whether or not a signal specifying the printing of the currently-browsed images has been received from the terminal device by the LAN interface 9 (S17). The user browsing the images by using the terminal device operates the terminal device to select the image desired to be printed from the currently-browsed images. The MPU 1 confirms via the LAN interface 9 whether or not such a printing has been specified through the terminal device.

At this time, when the signal specifying the printing has not been received by the LAN interface 9 (“NO” in S17) because the user ends the browsing by using the terminal device, for example, the communication between the LAN interface 9 and the terminal device is ended, and the process returns to S4. When the signal specifying such a printing has been received from the terminal device by the LAN interface 9 (“YES” in S17), the process proceeds to S14, where the MPU 1 turns on the switch SW2 to restore the normal mode of the MFP. In S15, the MPU 1 analyzes the signal received from the terminal device by the LAN interface 9 and confirms the image data to be printed.

In S15, when the memory controller 4 reads out the image data desired by the user by using the terminal device from the SDRAM 5, the image data is expanded by the CODEC 6 and then sent to the image processing circuit 11. Similarly to the printing operation using the network printer function, the MPU 1 operates the image processing circuit 11, the printer mechanism control circuit 12, and the printer engine 13, and the image of the image data desired by the user is printed on the paper.

When browsing, by using the terminal device, the image data stored in the SDRAM 5 after the facsimile reception, and when a browsing instruction is received from the terminal device by the LAN interface 9, the entire image data stored in the SDRAM 5 may be transmitted to the terminal device in S16. Alternatively, the image data stored in the SDRAM 5 may be selected by the terminal device, and only the selected image data may be transmitted to the terminal device in S16. When selecting the image data for printing while the image data is browsed by using the terminal device, the image data to be printed may be selected one by one, or the entire image data to be printed may be selected at one time.

2. Operations in the Energy-Saving Mode in the Standby State

Next, with reference to the flowchart of FIG. 3, operations performed after the switch SW1 is turned off in S5 of the flowchart of FIG. 2 while the MFP of FIG. 1 operates in the normal mode and after the MFP enters into the energy-saving mode are now described. As described above, when the switch SW1 is turned off, the power supply from the commercial power 300 to each of the second and third power supply circuits 201, 202 is cut. Accordingly, the power supply from each of the second and third power supply circuits 201, 202 is cut, and thus the MFP shifts to the energy-saving mode in which only the first power supply circuit 200 always supplies the power.

Having shifted to the energy-saving mode, an operation on the power-saving key 10 is detected by the MPU 1 (S101). When the user operates the power-saving key 10 (“YES” in S101), the MPU 1 turns on the switch SW1 in order to confirm a request for restoration of the normal mode (S102). The third power supply circuit 202 and the commercial power 300 are electrically connected, and the power supply from the third power supply circuit 202 to the third section 102 is resumed. Thus, the sub-system controller 21 is driven, the restoration of the normal mode is displayed on the display unit 23, and the operation unit 22 can receive operations.

Then, the MPU 1 checks an amount of data stored in the SDRAM 5, and confirms whether or not the amount reaches a prescribed upper limit amount of data (S103). When the amount of data stored in the SDRAM 5 falls below the prescribed amount of data (“NO” in S103), the MPU 1 returns to S6 of the flowchart of FIG. 2, and determines whether or not the restoration of the normal mode has been requested. When the amount of data stored in the SDRAM 5 reaches the prescribed amount of data (“YES” in S103), the MPU 1 turns on the switch SW2 (S104).

Thus, similarly to the operation performed in S9 (refer to FIG. 2), the power supply from the second power supply circuit 201 is resumed, and the MFP restores the normal mode. Accordingly, the power is supplied to the image processing circuit 11, the printer mechanism control circuit 12, and the printer engine 13. Thus, the image processing circuit 11, the printer mechanism control circuit 12, and the printer engine 13 are operated, and the images based on the image data stored in the SDRAM 5 are sequentially printed on the paper (S105).

In other words, when each of the received image data stored in the SDRAM 5 is read out by the memory controller 4, each of the image data is expanded by the CODEC 6 and then sent to the image processing circuit 11. Then, the image data is sent from the image processing circuit 11 to the printer engine 13 driven by the printer mechanism control circuit 12, and the image of each of the received image data stored in the SDRAM 5 is printed on the paper. When the printing of the images of the entire image data stored in the SDRAM 5 is completed, the MFP enters into the standby state in the normal mode, and the process returns to S1 of the flowchart of FIG. 2.

When the operation on the power-saving key 10 by the user is not confirmed (“NO” in S101), similarly to S8 of FIG. 2, the MPU 1 confirms whether or not a facsimile has been received by the MODEM 7 and the NCU 8 (S106). Then, when the MPU 1 confirms the facsimile reception performed by the MODEM 7 and the NCU 8 (“YES” in S106), similarly to S103, the MPU 1 confirms whether or not the amount of data stored in the SDRAM 5 reaches the prescribed upper limit amount of data (S107).

At this time, when the amount of data stored in the SDRAM 5 falls below the prescribed amount of data (“NO” in S107), the MPU 1 determines that image data can be stored in the SDRAM 5, and the image data received via facsimile is stored in the SDRAM 5 (S108). That is, when a signal from another facsimile machine is received by the NCU 8, the received signal is demodulated by the MODEM 7, and compressed image data is acquired. The image data acquired by being demodulated by the MODEM 7 is sent to the memory controller 4 and stored in the SDRAM 5 as the received image data. Then, the process returns to S101, where the MPU 1 confirms whether or not the power-saving key 10 has been operated again.

When the amount of data stored in the SDRAM 5 reaches the prescribed amount of data (“YES” in S107), similarly to S102, the MPU 1 turns on the switch SW1 to resume the power supply from the third power supply circuit 202 (S109). Then, the process returns to S104, where the MPU 1 turns on the switch SW2 to resume the power supply from the second power supply circuit 201, and thus the MFP restores the normal mode.

In S105, after the image of the image data stored in the SDRAM 5 is printed on the paper, the process returns to S1 of FIG. 2. At the time of the operation performed in S105, the image data acquired by being received by the MODEM 7 and the NCU 8 may be stored in the SDRAM 5, or the image thereof may be printed on the paper similarly to the image already stored in the SDRAM 5.

When the facsimile reception is not confirmed (“NO” in S106), similarly to S11 of FIG. 2, the MPU 1 confirms whether or not the terminal device has accessed the MFP via the LAN interface 9 (S110). At this time, when the signal reception by the LAN interface 9 is not confirmed (“NO” in S110), the process returns to S101, where the MPU 1 confirms whether or not the power-saving key 10 has been operated. When the signal transmitted from the terminal device provided on the LAN is received by the LAN interface 9, and the MPU 1 confirms the access made by the terminal device (“YES” in S110), similarly to S12 of FIG. 2, the MPU 1 confirms the content of the request made by the terminal device (S111).

When the content requested by the terminal device indicates a facsimile transmission using the network facsimile function (“FAX transmission” of S111), similarly to S13 of FIG. 2, the MFP transmits, via facsimile, the image data received through the LAN interface 9 (S112). The facsimile transmission using the network facsimile function can be performed by only the first section 100 to which the power is supplied from the first power supply circuit 200. When the facsimile transmission using the network facsimile function is completed, the MFP returns to S101.

When the content requested by the terminal device indicates an operation that uses the network printer function or the network scanner function (“scanner, printer” of S111), similarly to the operations of S102 and S109, the MPU 1 turns on the switch SW1 (S113). Thus, the power supply from the third power supply circuit 202 is resumed. Then, the process returns to S14 of FIG. 2, where the MFP restores the normal mode and then executes operations in accordance with the specified function.

When the content requested by the terminal device indicates a browsing of the image of the image data stored in the SDRAM 5 (“image browsing” of S111), similarly to S16 of FIG. 2, the transmission of the image data stored in the SDRAM 5 to the terminal device is executed (S114). Having received the image data transmitted from the LAN interface 9, the terminal device displays the image of the received image data on the display, and the user browses the image.

While the image data stored in the SDRAM 5 is browsed by using the terminal device, similarly to S17 of FIG. 2, the MPU 1 confirms whether or not the terminal device has instructed to print the currently-browsed image (S115). At this time, when the signal specifying the printing is not received by the LAN interface 9 (“NO” in S115), the LAN interface 9 ends the communication with the terminal device, and the MPU 1 returns to the process of S101.

When the signal specifying the printing is received from the terminal device by the LAN interface 9 (“YES” in S115), the process proceeds to S113, where the MPU 1 turns on the switch SW1, and the process returns to S14 of FIG. 2. After the MFP restores the normal mode, the image of the image data specified by the terminal device to be printed is printed on the paper in the process of S15 of FIG. 2.

When the MFP of FIG. 1 operates in accordance with the flowcharts of FIGS. 2 and 3 to shift from the normal mode in the standby state to the energy-saving mode, the switches SW2 and SW1 are sequentially turned off, and the mode shifts to the energy-saving mode in stages. On the other hand, when shifting from the energy-saving mode in the standby state to the normal mode, the MPU 1 turns on the switches SW1 and SW2 in stages in accordance with the instructed operations. Further, when only the operations of the first section 100 are sufficient, since the operations can be performed with the switches SW1 and SW2 turned off, the power consumption of the MFP can be reduced.

While the MFP is in the standby state in the normal mode, when the facsimile is received as described above, the image based on the received image data is printed, however, the image data may be temporarily stored in the SDRAM 5. In such a case, when the amount of data stored in the SDRAM 5 reaches the prescribed amount, or when the printing is specified through the operation of the operation unit 22 or through the access from the terminal device, the image based on the image data may be printed on the paper. Furthermore, when the printing is specified through the operation of the operation unit 22 or through the access from the terminal device, the image data to be printed may be selected from the image data stored in the SDRAM 5.

The present invention is not limited to the MFP illustrated in FIG. 1, and may be applied to any MFP including a facsimile function combined with any of scanner, printer and copying functions as long as the MFP is an image processing apparatus that includes the facsimile function and can be connected with the LAN.

While the present invention has been described with respect to embodiments thereof, it will be apparent to those skilled in the art that the disclosed invention may be modified in numerous ways and may assume many embodiments other than those specifically set out and described above. Accordingly, the appended claims cover all modifications that fall within the true spirit and scope of the present invention.

What is claimed is:

1. An image processing apparatus comprising:
a facsimile communication unit that transmits and receives data by being connected with a Public Switched Telephone Network;
a network communication unit that transmits and receives data by being connected with an area network;
a memory that stores the data;
a power supply that supplies components with power; and
a determination unit that determines whether or not to release an energy-saving mode in which power is supplied only to a portion of the components, wherein
at the time of operating in the energy-saving mode, at least the facsimile communication unit, the network communication unit, the memory, and the determination unit are supplied with power;
when the facsimile communication unit receives the data at a time of operating in the energy-saving mode, the received data is stored in the memory; and
when the network communication unit receives a request from a terminal device provided on the area network at the time of operating in the energy-saving mode, the determination unit determines whether or not to release the energy-saving mode in accordance with a content of the received request.

2. The image processing apparatus according to claim 1, wherein when the facsimile communication unit receives the data at the time of operating in the energy-saving mode, the determination unit determines whether or not to release the energy-saving mode in accordance with an amount of data stored in the memory.

3. The image processing apparatus according to claim 1, wherein
the power supply is cut with respect to a printer unit at the time of operating in the energy-saving mode; and
when the network communication unit receives the request from the terminal device provided on the network at the time of operating in the energy-saving mode, and when the received request requires a printing operation performed by the printer unit, the determination unit gives an energy-saving-mode release instruction.

4. The image processing apparatus according to claim 1, wherein when the network communication unit receives the request from the terminal device provided on the network at the time of operating in the energy-saving mode, and when the received request requires a transfer of the data stored in the memory to the terminal device, the determination unit gives an energy-saving-mode maintaining instruction.

5. The image processing apparatus according to claim 1, further comprising:
a first power supply circuit that always supplies power to a first section that operates even in the energy-saving mode;
a second power supply circuit that supplies power to a second section, excluding the first section, when the energy-saving mode is released, wherein
the first section includes at least the facsimile communication unit, the network communication unit, the memory, and the determination unit.

6. The image processing apparatus according to claim 3, further comprising:
a temperature detecting unit that detects a temperature of an inside of the image processing apparatus, wherein
at the time of shifting from a normal mode in which the power is also supplied to the printer unit to the energy-saving mode, after the power supply is cut with respect to at least the printer unit, when the determination unit confirms that the temperature detected by the temperature detecting unit falls below a predetermined value, the power supply is cut with respect to at least the temperature detecting unit, and the normal mode completely shifts to the energy-saving mode.

7. The image processing apparatus according to claim 6, further comprising:
a first power supply circuit that always supplies power to a first section that operates even in the energy-saving mode;
a second power supply circuit that supplies power to a second section that operates only in the normal mode; and
a third power supply circuit that supplies power to a third section, excluding the first section and the second section, which third section does not operate when the normal mode has completely shifted to the energy-saving mode, wherein
the first section includes at least the facsimile communication unit, the network communication unit, the memory, and the determination unit, and
the third section includes at least the temperature detecting unit.

8. An image processing apparatus comprising:
means for transmitting and receiving data via facsimile by being connected with a Public Switched Telephone Network;
means for supplying power to components;
means for setting an energy-saving mode in which the power is supplied for at least facsimile communication, network communication, and a memory;
means for storing the data in the memory in the energy-saving mode when a facsimile is received; and
means for releasing the energy-saving mode in accordance with a content of a request when the request is received in the energy-saving mode from a terminal device provided on a network.

9. The image processing apparatus according to claim 8, further comprising:
means for determining an amount of data stored in the memory; and
means for releasing the energy-saving mode at a time of facsimile reception based on the determined amount of data.

10. The image processing apparatus according to claim 8, further comprising:
means for cutting the power supply with respect to a printer unit in the energy-saving mode;
means for receiving the request in the energy-saving mode from the terminal device provided on the network; and
means for releasing the energy-saving mode when the received request requires a printing operation performed by the printer unit.

11. The image processing apparatus according to claim 8, further comprising:
means for receiving the request in the energy-saving mode from the terminal device provided on the network; and
means for maintaining the energy-saving mode when the received request requires a transfer of the data stored in the memory to the terminal device.

12. The image processing apparatus according to claim 8, further comprising:
means for always supplying power to a first section that operates even in the energy-saving mode; and
means for supplying power to a second section, excluding the first section, when the energy-saving mode is released, wherein
the first section includes at least a facsimile communication unit, a network communication unit, and the memory.

13. The image processing apparatus according to claim 12, further comprising:
means for detecting a temperature of an inside of the image processing apparatus;
means for cutting the power supply with respect to at least a printer unit at the time of shifting from a normal mode to the energy-saving mode; and
means for cutting the power supply with respect to at least the temperature detecting unit and for completely shifting to the energy-saving mode when the detected temperature falls below a predetermined value.

14. The image processing apparatus according to claim 13, further comprising:
means for always supplying power to the first section that operates even in the energy-saving mode;
means for supplying power to the second section that operates only in the normal mode; and
means for supplying power to a third section, excluding the first section and the second section, which third section does not operate when the normal mode has completely shifted to the energy-saving mode, wherein
the first section includes at least the facsimile communication unit, the network communication unit, and the memory, and
the third section includes at least the means for detecting the temperature of the inside of the image processing apparatus.

15. An energy-saving control method of an image processing apparatus, the method comprising the steps of:
supplying power to minimum necessary components in an energy-saving mode;
storing received image data when a facsimile reception is detected;
receiving a request from a terminal device via a network;
determining a content of the received request;
responding to the request while maintaining the energy-saving mode when the request specifies a facsimile transmission or a browsing operation;
releasing the energy-saving mode when the request specifies a printing operation, and then resuming the power supply to a printer unit; and
printing an image based on the image data.

16. The energy-saving control method of the image processing apparatus according to claim 15, the method further comprising the steps of:
detecting that a key of an operation panel has not been operated for a prescribed period of time; and
shifting to the energy-saving mode when the key has not been operated for the prescribed period of time.

17. The energy-saving control method of the image processing apparatus according to claim 16, the method further comprising the steps of:
detecting a temperature of the apparatus when the key has not been operated for the prescribed period of time; and
shifting to the energy-saving mode when the temperature of the apparatus falls below a predetermined temperature.

18. The energy-saving control method of the image processing apparatus according to claim 15, the method further comprising the steps of:
determining whether or not an amount of data stored in a memory exceeds a predetermined value when a facsimile reception is detected;
releasing the energy-saving mode when the amount of data stored in the memory exceeds the predetermined value; and
printing an image based on the received image data.

19. The energy-saving control method of the image processing apparatus according to claim 15, the method further comprising the steps of:
releasing the energy-saving mode when a request of a terminal device indicates a printing of an image; and
printing the image.

20. The energy-saving control method of the image processing apparatus according to claim 15, the method further comprising the steps of:
releasing the energy-saving mode;
determining whether or not the amount of data stored in the memory exceeds the predetermined value; and
printing an image based on the image data stored in the memory when the amount of stored data exceeds the predetermined value.
